(19) United States
(12) Patent Application Publication
(10) Pub. No.: US 2013/0246067 A1
(43) Pub. Date: Sep. 19, 2013

(54) USER INTERFACE FOR PRODUCING AUTOMATED MEDICAL REPORTS AND A METHOD FOR UPDATING FIELDS OF SUCH INTERFACE ON THE FLY

(71) Applicant: Sylvain Mailhot, Rimouski (CA)

(72) Inventor: Sylvain Mailhot, Rimouski (CA)

(73) Assignee: Sylvain Mailhot, Pathologiste SPRCP inc, Rimouski (CA)

(21) Appl. No.: 13/421,285

(22) Filed: Mar. 15, 2012

(51) Int. Cl. G06F 3/048; G10L 13/00

(52) U.S. Cl. 704/260; 715/780; 715/716; 704/E13.001

(57) ABSTRACT

A system for producing automated medical reports. The interface includes a menu area and a medical report area which is distinct from the menu area. The menu area includes a list of names representing medical conditions. The doctor may make different selections of names from the menu area as the medical service is being rendered to build a report in the medical report area. If a medical condition is not listed in the menu area, the doctor may add a new field for it and select/enter a name and a descriptor for the new field. Whereby, the field is automatically added in the menu area, and the name is automatically displayed in the new field without exiting the report/interface. Upon receiving a user selection of the new name, the descriptor associated therewith is retrieved from the memory and added in the medical report area without exiting the report/interface.

### CROSS REFERENCE TO RELATED APPLICATIONS

This application incorporates by reference the entirety of co-pending and co-owned U.S. Patent Application No. yet to be assigned entitled “Method and System for Producing Automated Medical Reports”, filed on the same date as the present application.

### BACKGROUND

(a) Field

The subject matter disclosed generally relates to a system and method for producing automated medical reports.

(b) Related Prior Art

Pathologists and health care professionals are under increased and conflicting pressures to produce medical records which are fully documented, and to provide the health care as efficiently as possible.

To produce a medical report, Pathologists and health care physicians tend to take notes (written notes, typed notes, or verbally recorded notes) when diagnosing a patient or examining a sample in the lab (blood, urine etc.). Subsequently, or at the end of the day, the physician dictates or hand writes the medical report based on the notes taken and sends the report to the assistant to type and formalize. After the report is formalized, it is sent back to the physician for review and signature.

This process is labor-intensive and slow, requiring processing by several personnel and taking several days to be produced. The process is also susceptible to errors due to many reasons including:

a) Human errors introduced by manual entry of the information;

b) Complexity of the terms used by the physician which makes it difficult for the assistant to correctly understand what they are hearing or reading;

c) The delay introduced between the diagnosing time and the time when the report is finalized;

Therefore, existing systems and medical devices lack the functionality that allows for producing machine generated medical reports as the medical service is being rendered to reduce time wasted and errors.

Another problem associated with the conventional systems, is that the medical reports produced are inscribed in a relatively free form fashion without any standardization of form and concept. This lack of structure often results in questions being asked about a rendered service, and several correspondences sent back and forth between the physician and third parties before the medical claims are settled.

A further problem associated with the conventional method is that physicians are forced to learn the language in which the report needs to be provided in order to be able to produce a medical report. This creates a problem for physicians who travel to other countries for practice and/or training, and for physicians who live in multilingual countries having more than one official language such as Canada, Switzerland, India, etc.

Therefore, there is a need for a system and method for producing medical reports, which address the above problems.

### SUMMARY

The present embodiments describe a method, system, and user interface for producing automated medical reports. The interface includes a menu area and a medical report area which is distinct from the menu area. The menu area includes a list of names representing medical conditions. The doctor may make different selections of names from the menu area as the medical service is being rendered to build a report in the medical report area. If a medical condition is not listed in the menu area, the doctor may add a new field for it and select/enter a name and a descriptor for the new field. Whereby, the field is automatically added in the menu area, and the name is automatically displayed in the new field without exiting the report/interface. Upon receiving a user selection of the new name, the descriptor associated therewith is retrieved from the memory and added in the medical report area without exiting the report/interface.

According to an embodiment, there is provided a method for updating fields of a user interface (interface) implemented on a display and used for generating automated medical report for a patient. The method comprises:
upon detection of a user selection to add a new field, prompting the user to enter a new name for the new field, the new name representing a medical condition or medical service, and a descriptor including detailed description of the medical condition or medical service associated with the new name;
storing the new name and the descriptor in memory;
automatically updating the interface by displaying the new name in a menu area of the user interface;
upon receiving a user selection of the new name from the menu area, accessing the descriptor associated with the new name from the memory and adding the descriptor in a medical report area of the user interface, the medical report area being distinct from the menu area.

According to an aspect, prompting comprises displaying a table for the user to enter the new name and the descriptor.

According to an aspect, prompting comprises displaying a browser window or a drop down menu for the user to select a pre-stored field.

According to an aspect, the method further comprises:
associating an audio clip with the new field, the audio clip representing a reading of at least one of: the medical condition or medical service associated with the new name, and the descriptor associated with the new name;
playing the audio clip upon receiving the user selection of the new name.

According to an aspect, associating comprises one of:
receiving a voice recording of the audio clip;
receiving a user selection of an existing audio clip; and
generating the audio clip using an automated text-to-audio program.

According to an aspect, the method further comprises, if the new name represents a new medical condition adding the new name in the menu area if privileges associated with a profile of the user indicate that the user is allowed to add generic names;

According to an aspect, the method further comprises sending the new name and the descriptor to an administrator for approval prior to adding the new name in the menu area if privileges associated with the profile of the user indicate that the user is not allowed to add generic names.

According to an aspect, the method further comprises, if the new name represents a new type of an existing medical condition, adding the new name in a drop down menu, the drop down menu being displayed upon receiving a user selection of the new name that represents the existing medical condition from the menu area.

According to an aspect, the method further comprises classifying the new field under one or more body areas whereby the new name appears in the menu area of the interface upon selection of each body organ under which the new name has been classified.

According to an aspect, the method further comprises:
storing one or more translations of the new field in memory;
cross referencing the different translations of names and descriptors for each field;
receiving a user selection of a language for at least one of: names in the menu area, descriptors in the medical report area, medical report viewed in the medical report area, medical report to be sent to third parties;

whereby the user may automatically produce equivalent medical reports in different languages.

According to an embodiment, there is provided a method for adding new fields in a user interface (interface) used for generating automated medical report for a patient, the interface comprising a menu area and a medical report area distinct from the menu area. The method comprises:
receiving a new name and a descriptor for a new field, the new name representing a medical condition or medical service and the descriptor including detailed description for the new name;
storing the new name and the descriptor in memory;
automatically allocating a space for the new field in the menu area, and automatically displaying the new name in the allocated space;
upon receiving a user selection of the new name from the menu area, adding the descriptor associated with the new name in the medical report area of the user interface to gradually build an automate medical report with every new selection of a name from the menu area.

According to an embodiment, there is provided a graphical user interface (interface) on a computing device comprising a memory having stored thereon computer instructions and a processor for executing the instructions for implementing the interface on a display device. The interface comprises:
a menu area comprising a list of names representing medical conditions or medical services;
a new field area which when selected allows for receiving a new name and a descriptor for the new field, adds the new field in the menu area, and adds the new name in the new field;
a medical report area, distinct from the menu area, for adding and displaying descriptors for the names with each user selection of a name from the menu area to generate a medical report.

According to an aspect, if the new name represents a new type of an existing medical condition, the interface adds the new name in a drop down menu, the drop down menu being displayed upon receiving a user selection of the name that represents the existing medical condition from the menu area.

According to an aspect, if the new name represents a new medical condition, the interface verifies privileges associated with a profile of the user and adds the new name in the menu area if the privileges indicate that the user is allowed to add generic names, or sends the new name and the descriptor to an administrator for approval prior to adding the name in the menu area if the privileges indicate that the user is not allowed to add generic names.

According to an aspect, the interface further comprises a language selection area which allows for selecting a language for at least one of: the names in the menu area and the medical report in the medical report area.

According to an aspect, the interface further comprises a file insertion area which allows for selecting a file and inserting one of: the file, a link thereto, and a sample thereof in the medical report area.

According to an aspect, upon detecting a user selection of a name from the menu area the interface causes the processor to play an audio clip representing a reading of the name and/or the descriptor associated with the name.

According to an aspect, upon detecting a user selection of a name representing a medical condition or a medical service having different types, the interface displays at least a portion of the different types in a drop down menu.

According to an aspect, the interface further comprises a tree-view area for displaying the names selected by the user in an order of selection, wherein changing the order of a selected name from the tree-view area causes an automatic change of order of the descriptor associated with the selected name in the medical report area.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates an example of a user interface for producing medical reports, in accordance with an embodiment;

FIG. 1a illustrates an example of a user interface including a filter;

FIG. 2a illustrates an exemplary table including a list of organs;

FIG. 2b illustrates an exemplary table including a list of diseases associated with an organ;

FIG. 3a illustrates an example of a sub-table including different types of the skin disease “Psoriasis”;

FIG. 3b illustrates an example of a sub-table including different types of the skin disease “Eczema”;

FIGS. 4a to 4g illustrate an example of how a medical report may be built concurrently as the doctor is examining the patient using an interface in accordance with the present embodiments;

FIGS. 4h and 4i illustrate an example of an interface including a tree-view area listing the order of names selected by the user from the menu area;

FIGS. 5a to 5c illustrate an example of an interface which allows the doctor to choose different languages for the items in the menu area and for the medical report in the report area of the interface;

FIG. 6a illustrates an example of an interface which allows for introducing a new field representing a generic disease in the menu area of the interface;

FIG. 6b illustrates an example of an interface which allows for introducing a new field representing a new type of an existing disease in the drop down menu of the existing disease;

FIGS. 7a to 7e illustrate different examples of adding new fields in an interface, in accordance with the present embodiments;

FIG. 8 is a flowchart of a method for updating fields of a user interface (interface) implemented on a display and used for generating automated medical report for a patient, in accordance with an embodiment;

FIG. 9 illustrates an embodiment of a computing environment in which embodiments of the present invention may be practiced.

It will be noted that throughout the appended drawings, like features are identified by like reference numerals.

### DETAILED DESCRIPTION

The present embodiments describe a system, method, and user interface for producing automated medical reports as the medical service is being rendered. A list of names representing medical conditions (or medical services) is stored in memory along with a descriptor including detailed description for each name. Each name may be classified under one or more body organs, whereby by choosing a body organ the list of names associated with the body organ is displayed in a menu area of a user interface. In cases where the name in the menu area is a generic name that has many types, it is possible to present/display the different types in a drop down menu when the generic name is selected. With each selection of a name (or a type) from the menu area, the descriptor associated with the selected name is added in a medical report area which is a distinct area of the interface. Whereby, an automated medical report is produced as the selections are being made.

It is possible however that one of the diseases/symptoms is not present in the menu area neither in one of the drop down menus. This is due to many reasons including the discovery of new diseases or the fact that the organ diagnosed has a large number of diseases that may affect it such that it is not possible to list them all in the menu area, or due to the fact that a certain disease has many different types such that it is not possible to list all the types in a single drop-down menu. The present embodiments describe an interface which allows updating the fields of the interface on the fly to add new fields or replace existing ones for the new names or new types of medical conditions while the report is being built and without leaving the interface. In an embodiment, the addition of fields is governed by a set of policies relating to the organization hierarchy.

Using the present system, method, and user interface pathologists, doctors, and health care professionals (hereinafter “doctors”) may produce automated medical reports on the fly as they render the medical service e.g. examine a patient, conduct testing on a sample in the lab, perform medical, review lab results etc.

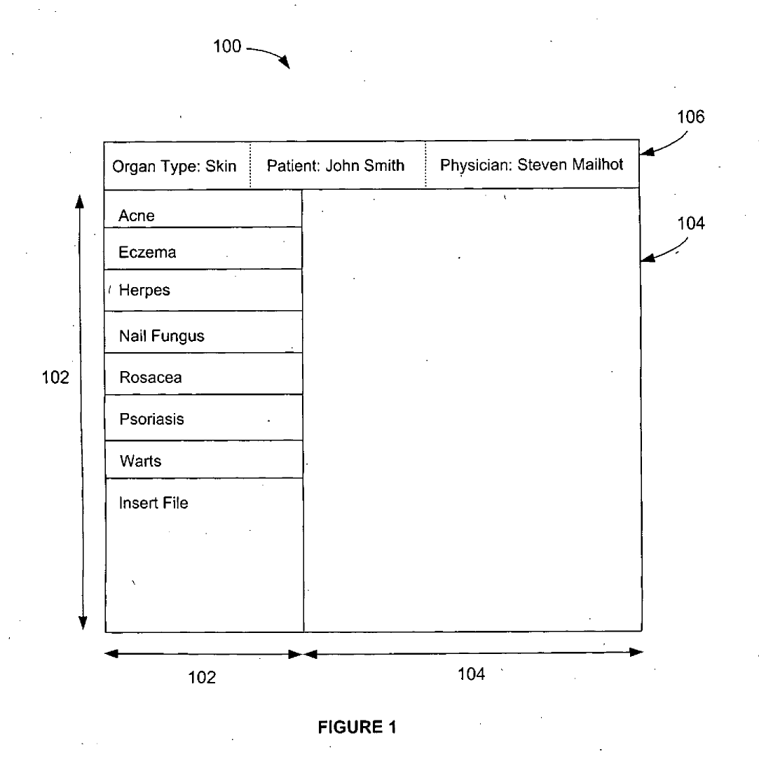

In the following description, the embodiments will be described in terms of a user interface, however, it should be noted that the embodiments may also be practiced and claimed as a method and/or a system. In an embodiment, the user interface comprises a menu area extending on a first area of the interface and a medical report area extending on a second area of interface. A non limiting example of such interface is shown in FIG. 1.

FIG. 1 illustrates an example of a user interface for producing medical reports, in accordance with an embodiment. As illustrated in FIG. 1, the interface 100 includes a menu area 102 from which the doctor may select one or more items, and a report area 104 in which the medical report is produced. Optionally, the interface may also include a third area 106 including other information such as the name of the doctor, name of the patient, an identification of the organ/sample/system that is being diagnosed/checked etc., and other related information and options such the medical history of the patient.

As shown in FIG. 1, the menu area 102 includes a list of options/items for the doctor to choose from. In a non limiting example of implementation, the items listed in the menu area 102 may represent generic types of medical conditions (hereinafter diseases).

In one embodiment, the diseases listed in the menu area 102 may be filtered based the organ that is being diagnosed. Accordingly, the items listed in the menu area 102 may vary between a doctor and the other depending on each doctor's specialty. In the following embodiments, the interface 100 is described as being used by a dermatologist, and thus, the items listed therein represent skin diseases. If however, the interface 100 is used by a cardiologist, the doctor may select “heart” as the organ type, and the interface would load heart diseases/symptoms in the menu area 102.

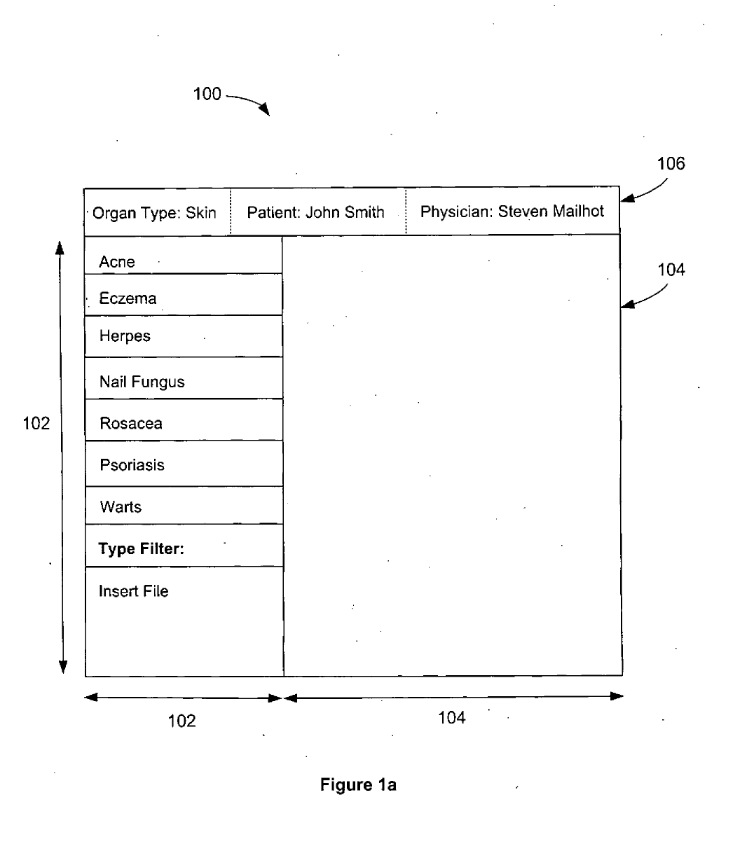

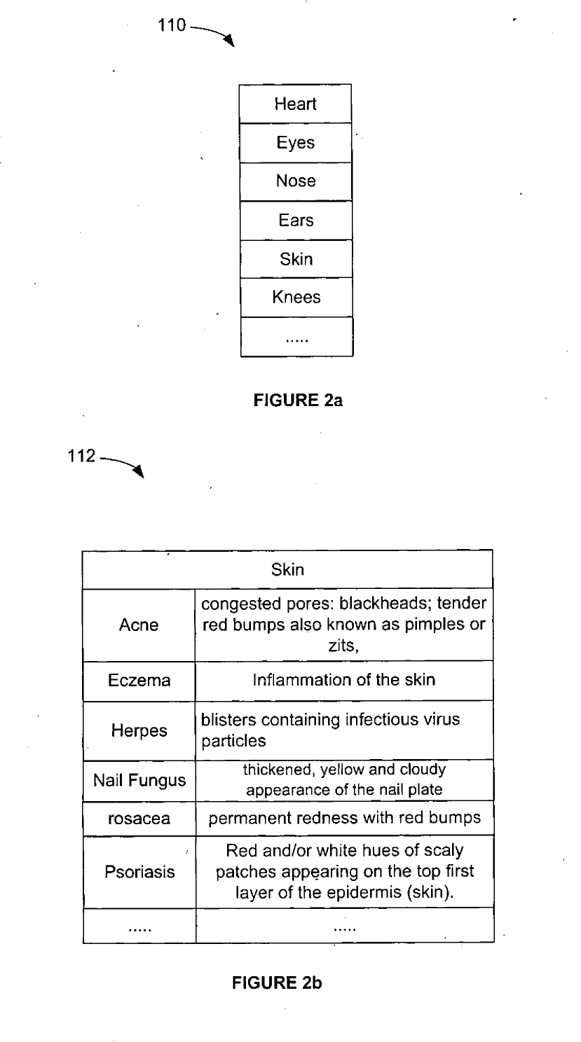

In an embodiment, the interface 100 may have access to a table 110 stored in a database/memory and including a list of organs. An example of such table is shown in FIG. 2a. In a non-limiting example of implementation, each organ in the table 110 points to another table 112 including a list of diseases associated with the selected organ. An example of the table 112 including skin diseases associated with the skin is illustrated in FIG. 2b. As shown in FIG. 2b, each disease may have a short name/code e.g. psoriasis, eczema, acne etc., and an expanded description that explains the symptoms/effects associated with the disease (hereinafter descriptor). Whereby, by selecting a certain organ from the table 110 the list of short names/codes for the different diseases associated with the selected organ would appear in the menu area 102 of the interface 100.

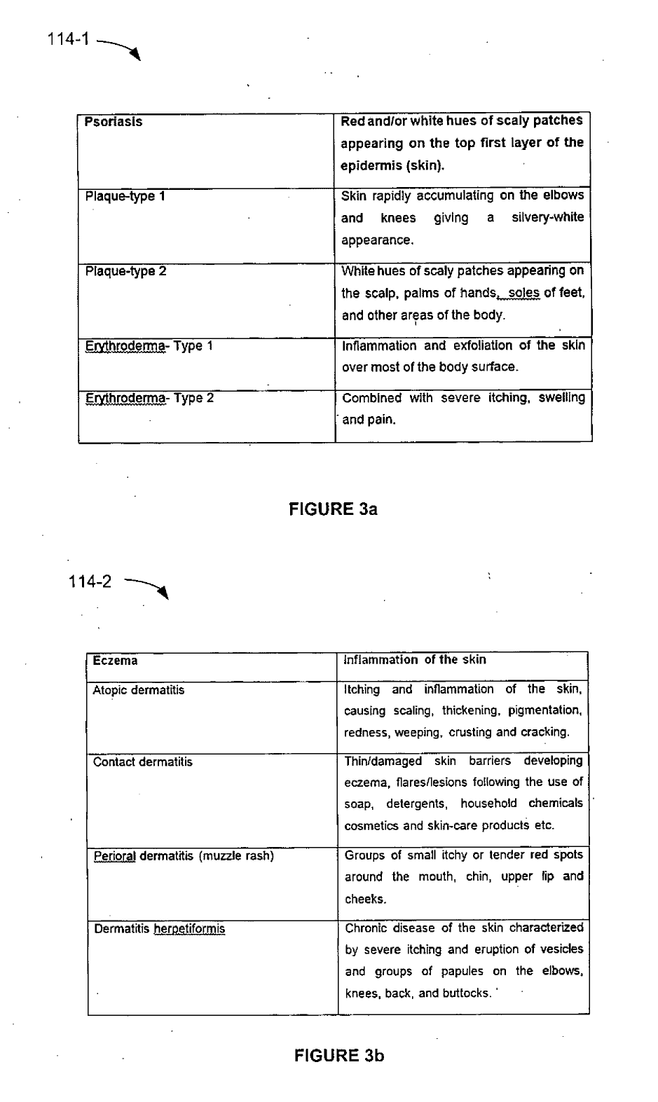

In an embodiment, the interface 100 may also include a filter area which allows the user to type in a filter to narrow down the choice of names in the menu area 102 and/or retrieve other names from the database. A non-limiting example is shown in FIG. 1a. If the user is searching for a disease that is not listed in the menu area 102 the user may type in the search query in the “Type Filter” area to retrieve the results. In an embodiment, the interface may search not only the list of names but also the descriptors associated with the names in order to retrieve search results. For example, if the user types the word “itch” in the filter area, the interface may return Eczema and Psoriasis as search results since both diseases have the word “itching” in the descriptor, as shown in FIGS. 3a and 3b. The filter may be configured to search within the diseases associated with a specific organ/body area or the entire list of names in the database.

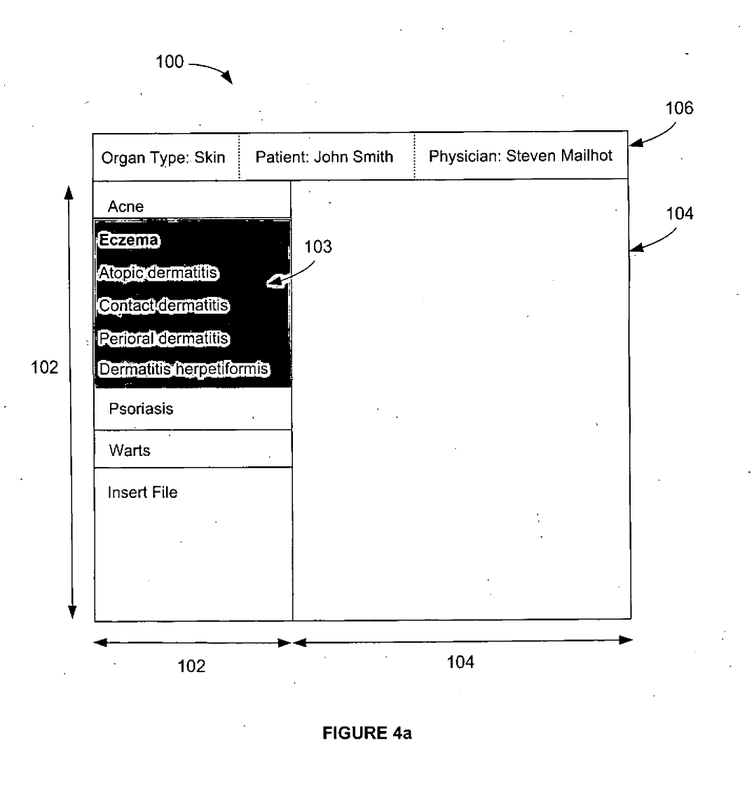

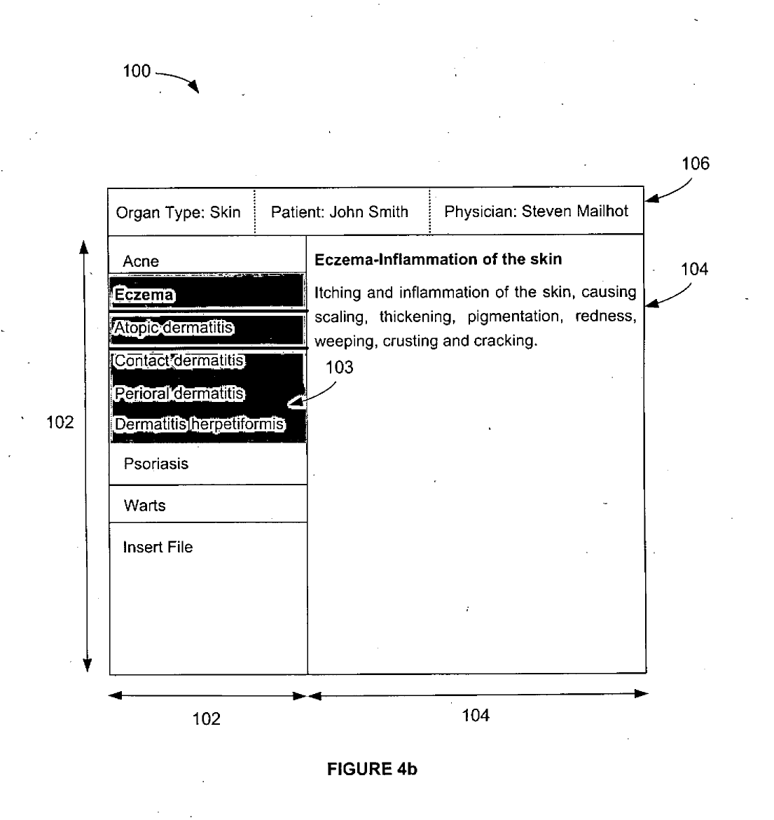

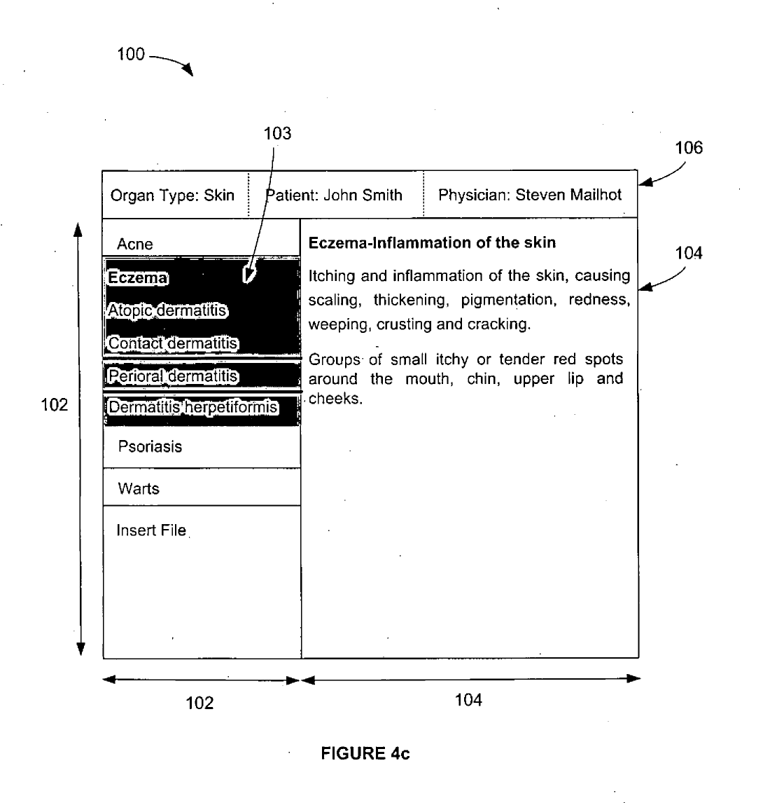

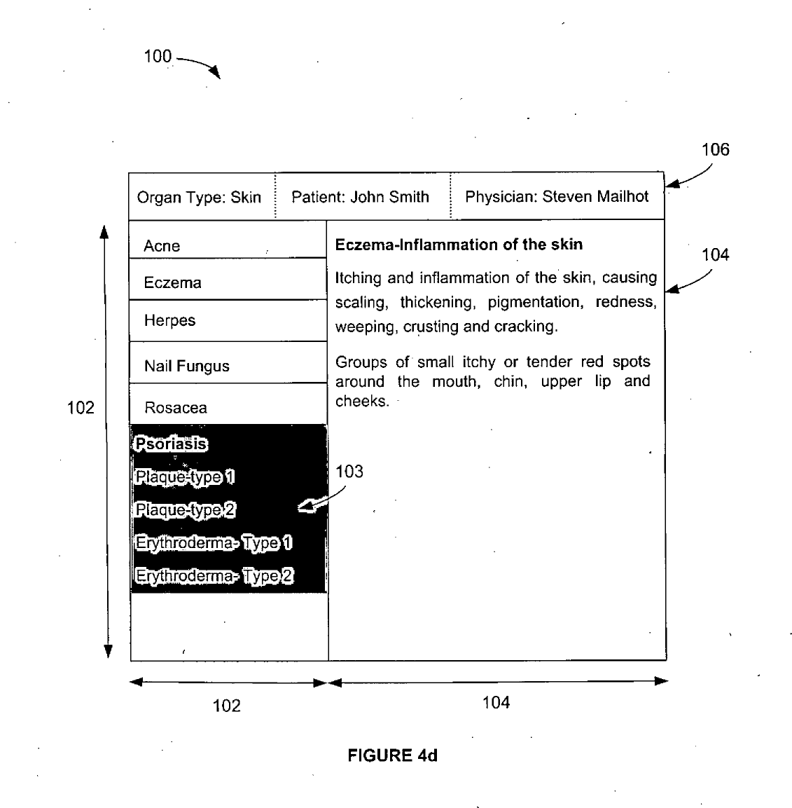

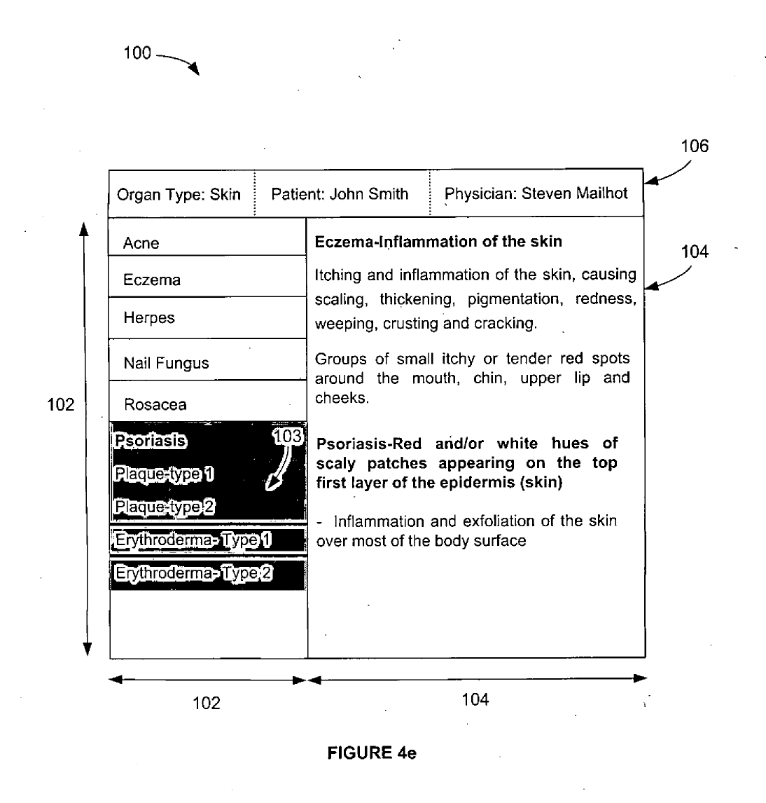

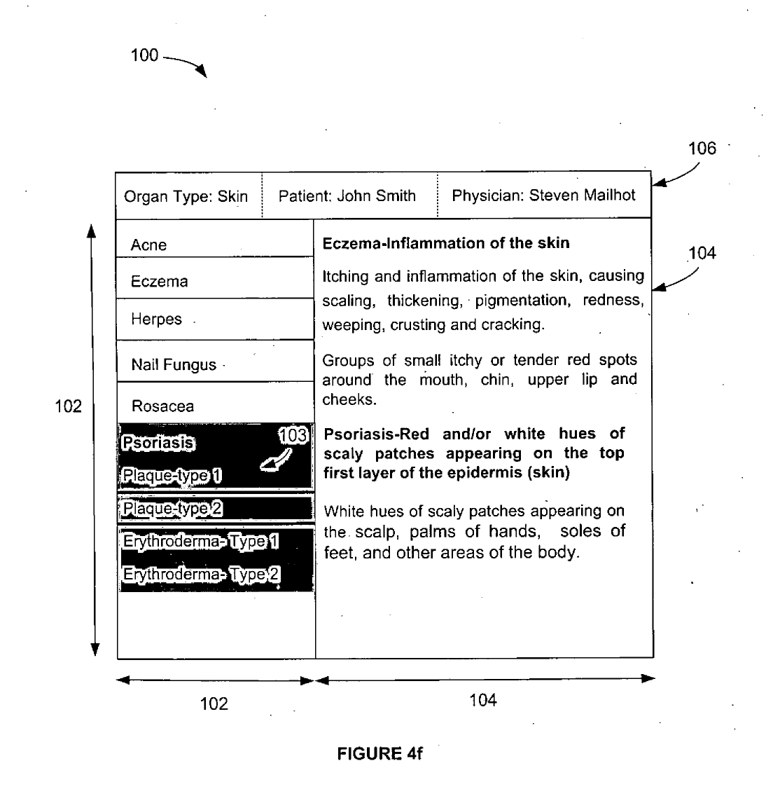

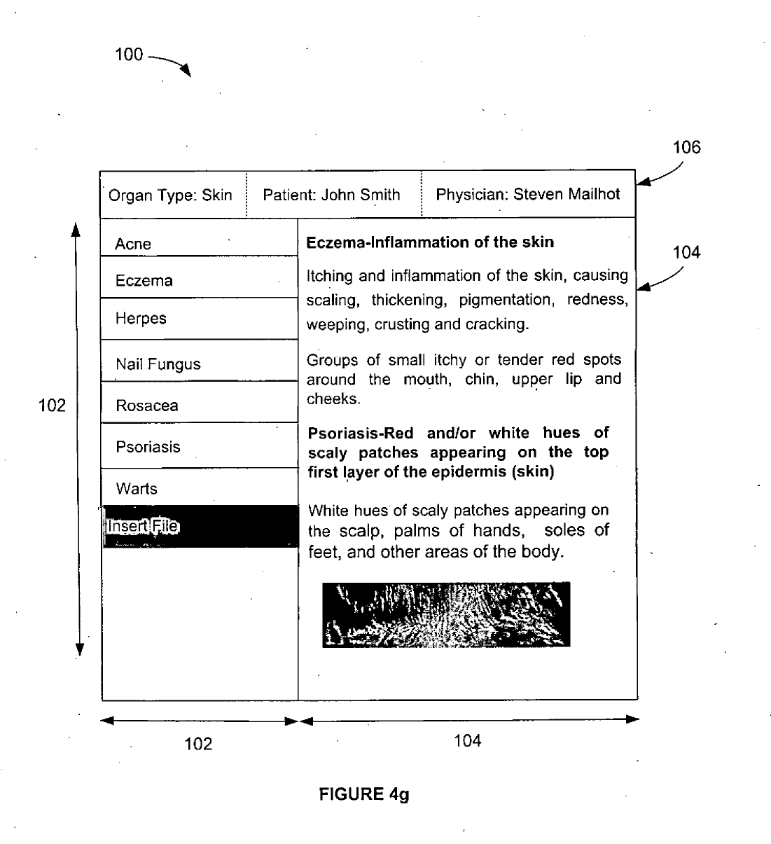

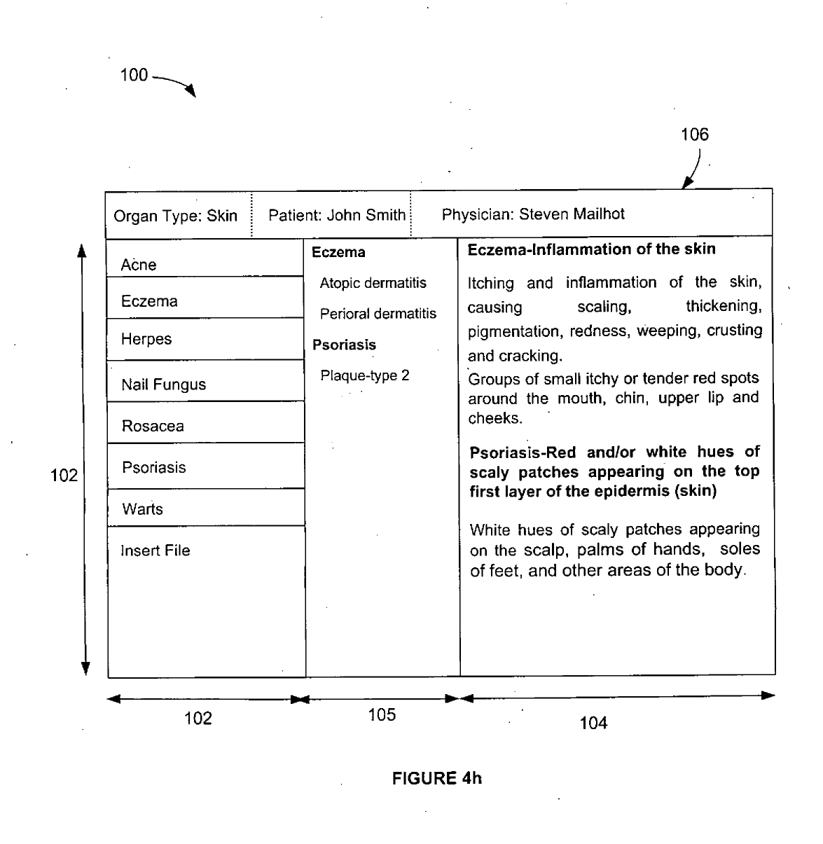

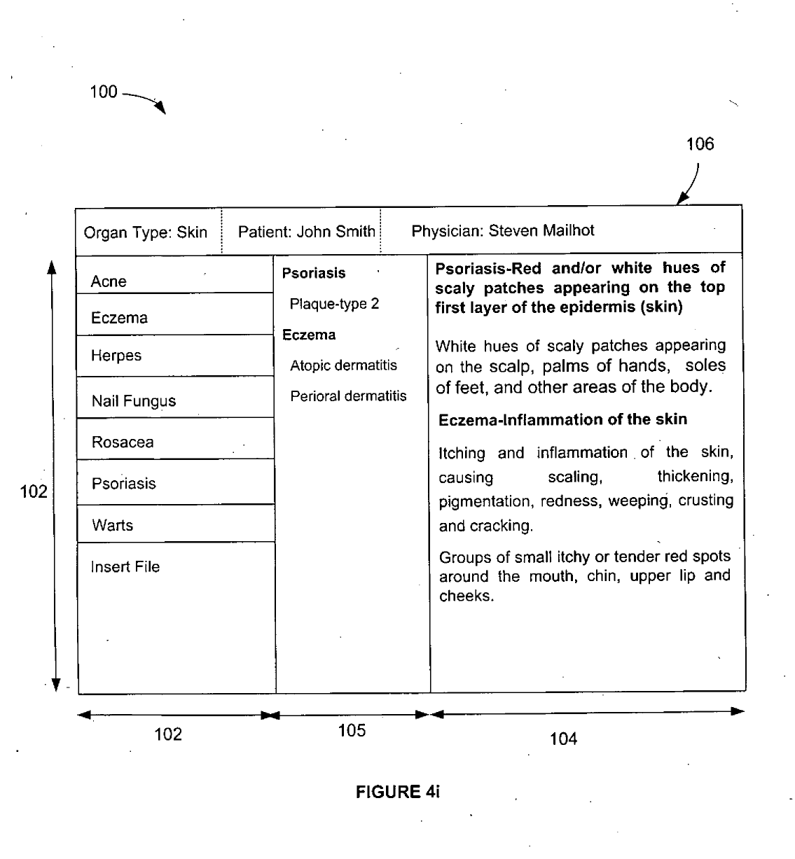

In most cases, however, a disease may have different types and/or different levels depending on how advanced/widely spread the disease is within the body. In these cases, sub-tables may be provided in the memory which include a short name/code for the generic disease (and optionally an expanded description about the generic disease), as well a list of the short names/codes for the different types/levels of the disease and a descriptor that explains the symptoms/effects for each type/level. An example of such sub-tables is shown in FIGS. 3a and 3b. FIGS. 3a illustrates an example of a sub-table 114-1 including different types of the skin disease “Psoriasis” and a descriptor for each type, and FIG. 3b illustrates an example of a sub-table 114-2 including different types of the skin disease “Eczema” and a descriptor for each type. In an embodiment, it is possible to enter a singular version of the descriptors and/or a plural version thereof. For example, it is possible to have a singular descriptor that recites “swelling of a finger”, and a plural version thereof that recites “swelling of the fingers”. There are many ways for configuring the interface to display the singular or plural version. A non limiting example may be to select the same name twice successively from the menu area to obtain the plural version of the descriptor. FIGS. 4a to 4e illustrate an example of how a medical report may be built concurrently as the doctor is rendering a medical service using an interface in accordance with the present embodiments.

As the doctor is rendering the medical service, they may select one or more of the items listed in the menu area 102 that best reflect the patient's condition/symptoms. The doctor may select an item using a pointing device such as a mouse or keyboard, or by pressing on the screen if the interface is implemented on a computing device including a touch sensitive display. By selecting an item from the menu area 102, the interface 100 retrieves the descriptor associated with that item (see FIGS. 2b to 3b) and adds it in the medical report area 104 automatically, whereby the doctor may visualize the progress of the report immediately as the examination proceeds.

If the selected disease has different types, as described above in the examples of FIGS. 3a and 3b, the interface would highlight the selected disease and present the different types thereof in a drop-down menu, as illustrated in the non-limiting example of FIG. 4a. Assuming that the patient is infected with Eczema type “Atopic dermatitis”, the doctor may select this type and the descriptor associated with this type (see FIG. 3a) is added automatically in the report area 104 as shown in FIG. 4b. If the doctor finds that the patient has also Eczema spots around the mouth, the doctor may also select the appropriate type (Perioral dematitis), and the descriptor associated with this type is added to the report in the report area 104, as shown in FIG. 4c.

The report is built gradually as the doctor is examining the patient. For example, if the doctor identifies other diseases they may repeat the same procedure, and the report keeps on being built. Assuming that the doctor finds that the patient is infected with Psoriasis (in addition to Eczema), they may select this disease and the drop down menu 103 appears, as shown in FIG. 4d. The doctor may choose the type of psoriasis, as shown in FIG. 4e and the descriptor associated with that type is added to the report in the report area 104. If the doctor finds that the selection was erroneous or inaccurate and wishes to correct the report, they may erase a certain description e.g. by unselecting a previously selected item, and selecting a new one, as shown in FIG. 4f where the doctor has substituted the type “erythroderma-type 1” with “Plaque Type 2”.

The report produced while the medical service is being rendered may be in the final format, ready to be sent to the appropriate parties.

In another embodiment, the doctor may insert photos (charts, diagrams, videos or any other type of files) within the report. In a non-limiting example of implementation the doctor may select “insert file” from the menu area 102 and browse to the desired directory to select the file and insert it in the appropriate area of the report, as shown in FIG. 4g.

FIG. 4h illustrates an example of an interface including a tree-view area. As shown in FIG. 4h, the tree-view area 105 includes the order of the selections made by the doctor. If the doctor wants to make changes to the medical report by moving a certain descriptor up or down in the report, the doctor may do so by selecting the corresponding name from the tree-view area 105 and moving/dragging it to the desired position in the tree-view area 105. Whereby, the interface 100 may updates the medical report automatically to reflect the changes made in the tree-view area 105.

For example, if in the interface of FIG. 4h, the doctor wants the psoriasis Plaque-type 2 to be presented as the first item in the medical report, the doctor may select the desired name and drag it to the desired position as illustrated in FIG. 4i. As illustrated in FIG. 4i, the Plaque-type 2 is now the first item in the tree-view and so is the corresponding descriptor in the medical report area 104.

In an embodiment, a voice clip is associated with each descriptor whereby when the doctor makes a selection, the descriptor associated with that selection appears in the report area 104 and the clip voice plays on the computing device to warn the doctor of the selection. The clip may include a voice recording representing a reading of the descriptor and/or the item selected from the menu area.

One of the advantages of this embodiment is that it helps preventing errors in the report. For example, referring back to the examples shown in FIGS. 4e and 4f, if the doctor meant to select plaque-type 2 and by mistake selected Erythroderma-Type 1 the voice clip may read Erythroderma-Type 1 . . . exfoliation of the skin, while the doctor has meant plaque-type 2 and is seeing hues of scaly patches appearing on the scalp . . . . Therefore, the voice clip of erroneous selection may includes terms that were not meant or expected by the doctor, which may trigger the doctor's attention to make the necessary corrections.

The voice clip may a pre-recorded clip for each descriptor or may be generated using a program that reads the content of the descriptor and produces an audio signal corresponding thereto.

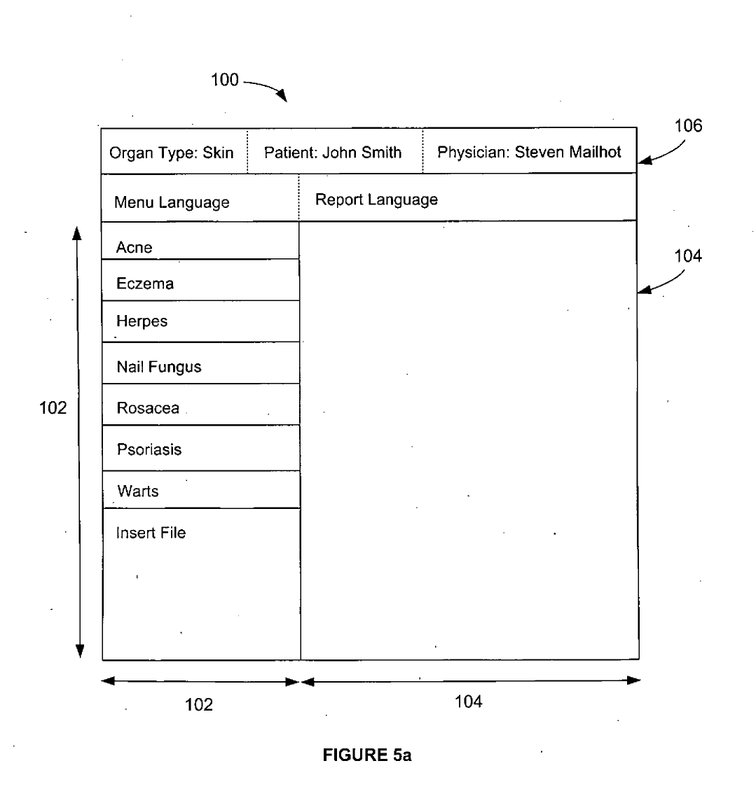

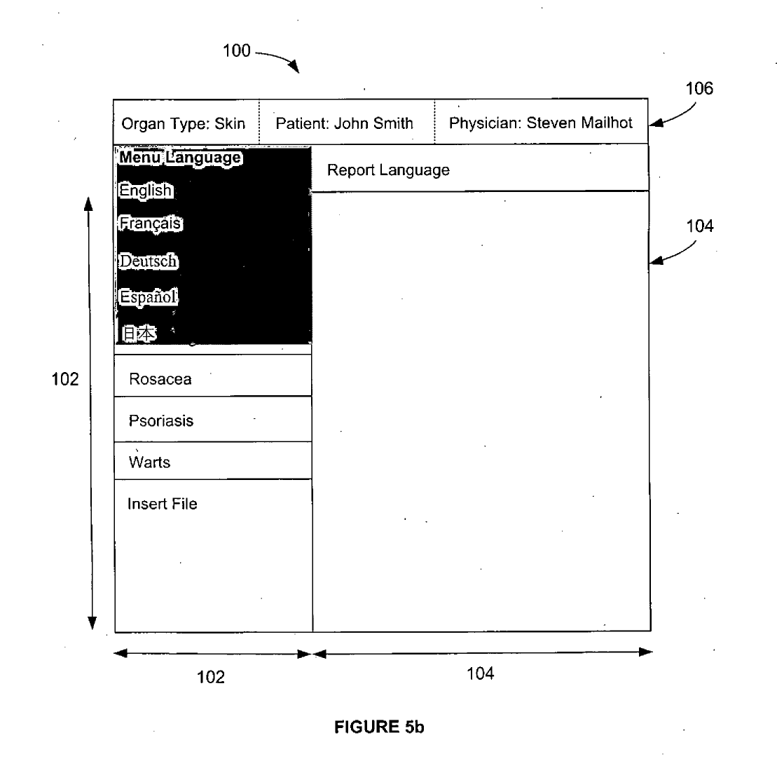

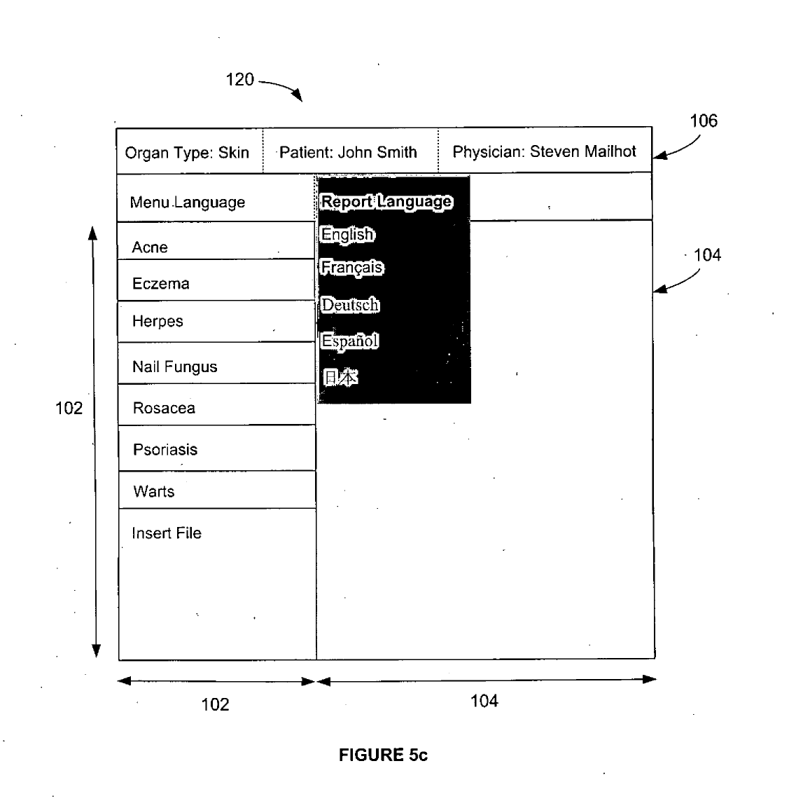

In a further embodiment, the interface may provide the doctor with the option of selecting the language of choice for the items in the menu area 102 and for the medical report in the report area 104, as exemplified in the interface illustrated in FIGS. 5a to 5c.

FIGS. 5a to 5c illustrate an example of an interface 120 which allows the doctor to choose different languages for the items in the menu area and for the medical report in the report area of the interface. Whereby, the doctor may diagnose the patient and select appropriate items from the menu area 102 in the language that the doctor masters, while the report is being filled in another language. In this case, the database may include different translations of the items in the menu area 102 and the descriptors associated with these items. In the present embodiment, the language of the voice clip may be set to be the same as that of the menu language, whereby the doctor may select an item and hear the description of that item in the language that he understands, while the report is being done in another language. Needless to say, it is also possible to have a separate language selection option for the voice clip, or to associate the language of the voice clip to the language of the report. It is also possible to choose one language for the entire interface.

The report may also be provided in different languages in respective areas of the interface, or by switching back and forth between one language and the other. In a further embodiment the doctor may view and/or produce the report in one language and send it the corresponding party in another language.

Accordingly, by standardizing the codes listed in the menu area 102 and/or the descriptors associated with these codes, doctors may produce standardized medical reports that are free of un-common medical language which results in questions being asked about a rendered service by third parties such as the insurance company or employer of the patient. Accordingly, the interface in accordance with the present embodiments saves the doctor's time by producing the medical report concurrently as the doctor is rendering the medical service, and reduces time spent in corresponding back and forth between the doctor and other parties such as the insurance company of the patient by producing a medical report with standardized language.

In an embodiment, it is possible to have more than one descriptor for each item in the menu area to produce different reports to be sent to different destinations. For example, assuming that the insurance companies have certain requirements for the format and structure of the medical report while the medical committee or the physicians supervising the doctor have other requirements e.g. the report has to include photos. In this scenario, it is possible to associate more than one descriptor for each item in the menu area, whereby by selecting the destination to which the medical report is to be sent, different medical reports may be automatically produced based on the same items selected from the menu area 102. For example, the doctor may view the medical report in the format that they are comfortable with and send another report to the insurance company in the format that the insurance company accepts. Needless to say, the doctor may preview the medical report and edit it before sending it if necessary. However, the doctor does not have to re-enter the items or reproduce the report from scratch because the items would be already selected.

As discussed above, it is possible that one of the medical conditions is not present in the menu area 102 neither in one of the drop down menus 103. This is due to many reasons including the discovery of new diseases, new types of existing diseases or the fact that the organ diagnosed has a large number of diseases that may affect it such that it is not possible to list them all in the menu area 102, or due to the fact that a certain disease has many different types such that it is not possible to list all the types in a single drop-down menu 103.

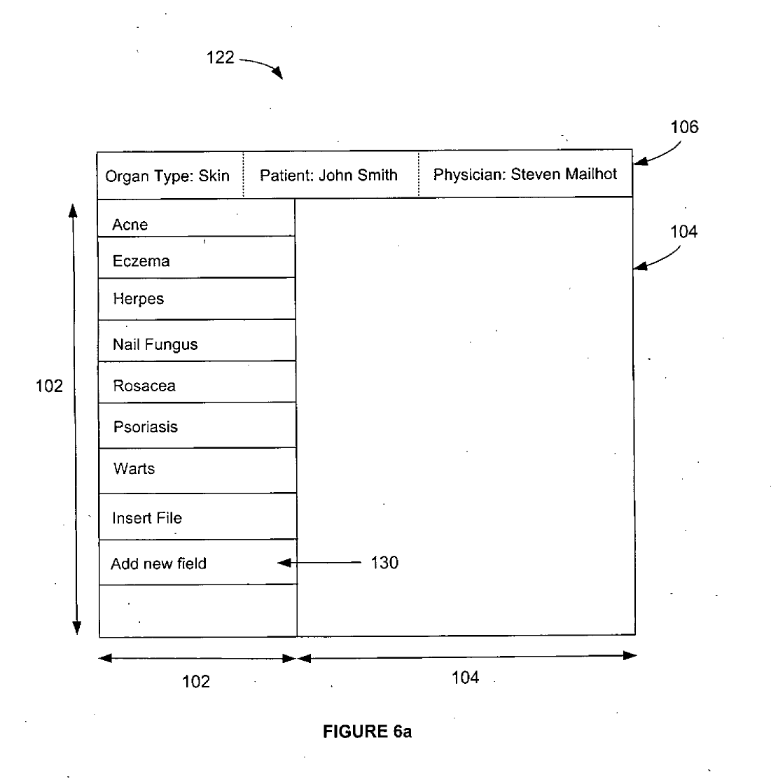

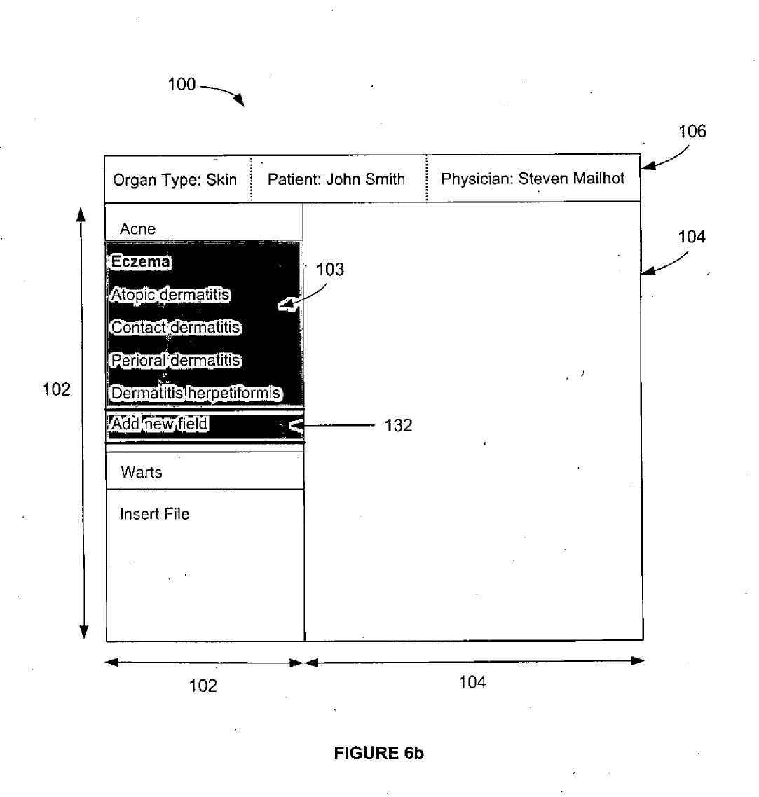

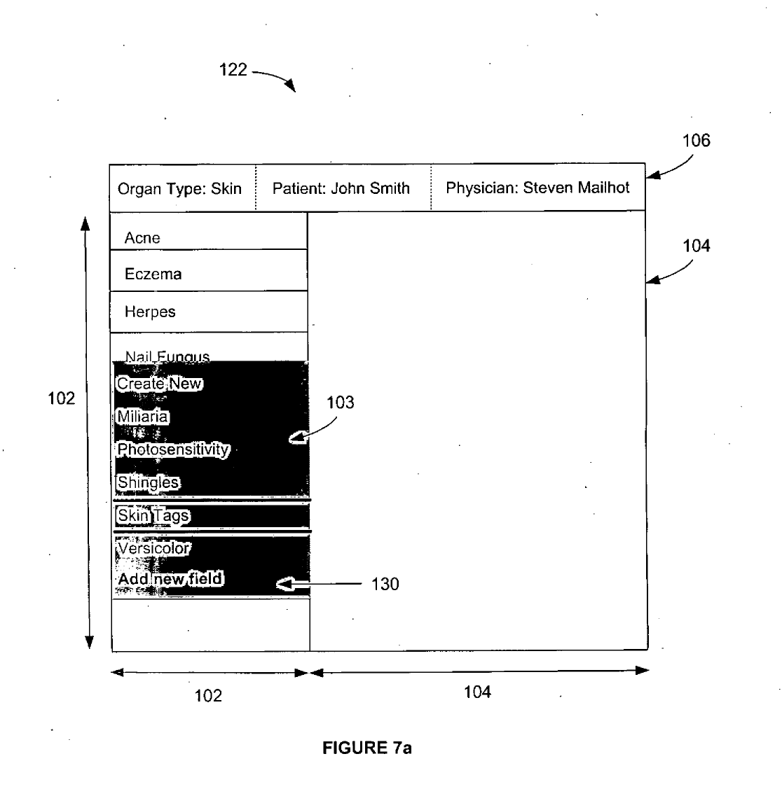

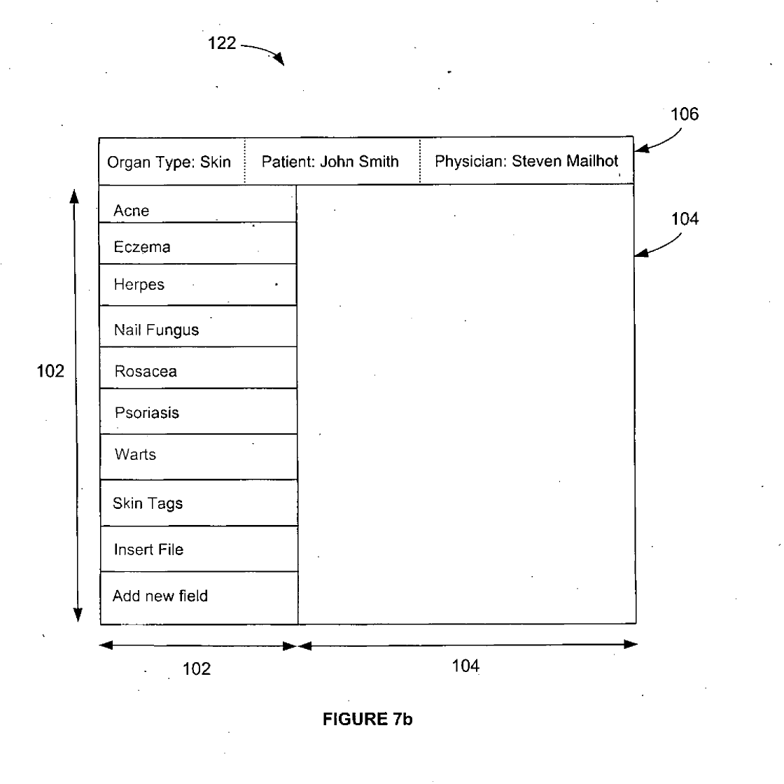

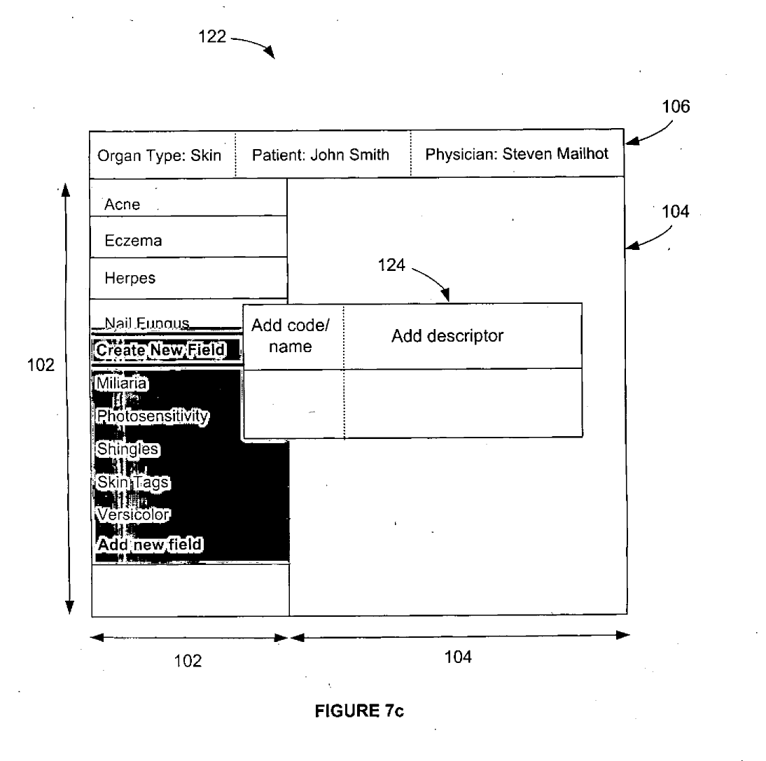

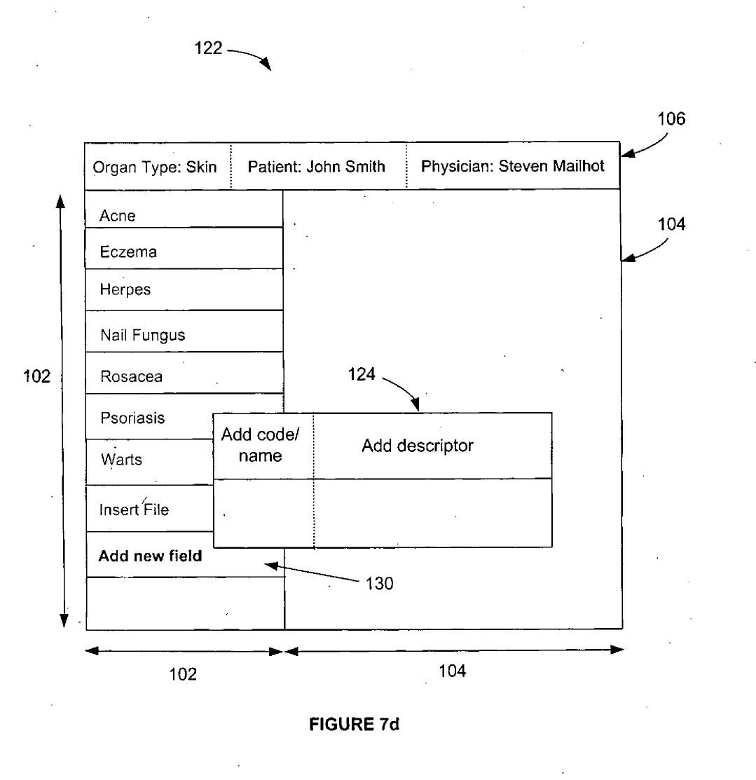

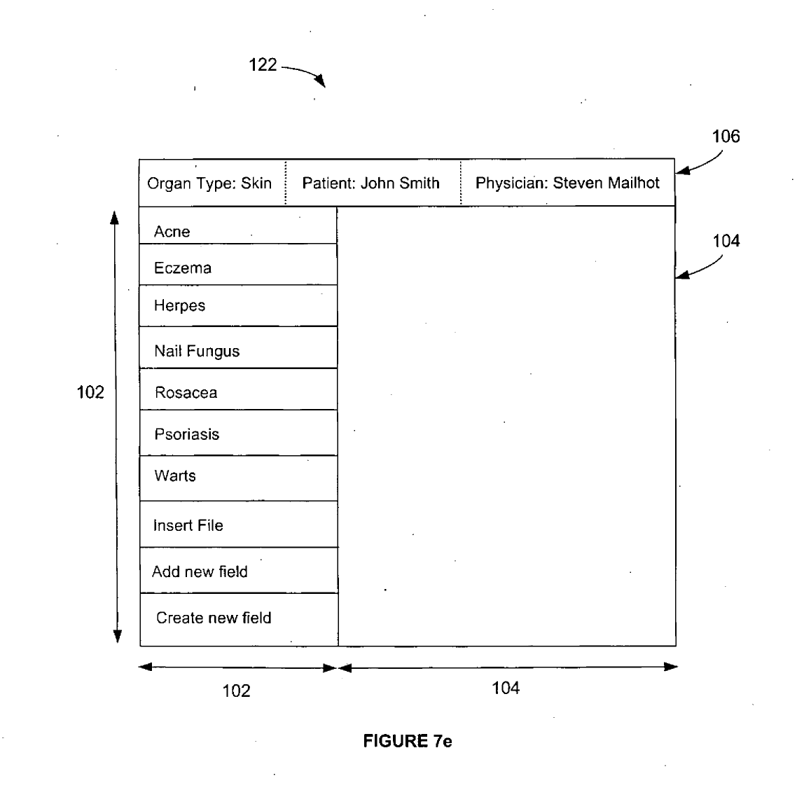

In an embodiment, the interface may provide the option to add a new field on the fly, whereby by selecting this option the doctor may create a new field representing a new disease (or a new type of an existing disease), or add an existing disease in the menu area 102 (or add an existing disease type in the drop down menu of an existing disease) and continue with the building of the report without having to exist the interface or the report. An example is shown in FIGS. 6a to 7d.

FIG. 6a illustrates an example of an interface which allows for introducing a new field in the menu area of the interface. For example, if the field to be added represents a generic medical condition, the doctor may click on/touch the area “Add new field” 130 in the menu area 102 to enter a new name in the menu area 102 of the interface. In the example of FIG. 6a, the doctor may click on the field “Add new field” 130 to add a new skin disease in the menu area 102.

FIG. 6b illustrates an example of an interface which allows for adding a new field in the drop down menu of the existing disease. The exemplary interface of FIG. 6b may be used when the new field to be added represents a new type of an existing disease. For example, if the doctor wants to add a new type of Eczema, they may click on Eczema and click on/touch the area “Add new field” 132 from the drop down menu 103 to enter or select the new type.

The adding of the new field may also be done in a variety of ways. In the following embodiments, examples are provided which describe the adding of a new field in the menu area 102 as in FIG. 6a. However, the same examples may also be applied to adding new fields in the drop down menu of an existing disease as in FIG. 6b.

FIGS. 7a to 7e illustrate different examples of adding new fields in an interface, in accordance with the present embodiments. For example, if the new field already exists but is not displayed, it may be selected from a list. Otherwise, it may be manually entered by the doctor. FIG. 7a illustrates an example of an interface which allows for adding a new field by selecting an item from a drop down menu. For example, if there are other skin diseases which are not listed in the menu area e.g. due to the presence of many of them, they may be listed in a drop down menu 103 under the “add new field” option 130. Whereby, the doctor may select one of them to add in the menu area 102, as shown in FIG. 7a.

When a new field is added, the interface is updated automatically to add the name of the new field in the menu area 102 (or one of the drop-down menus 103). For example, if in FIG. 7a the doctor adds “Skin Tags” the name “Skin tags” automatically appears in the menu area 102 as a selectable option, as shown in FIG. 7b. FIG. 7b illustrates the interface of FIG. 6a after adding a new field in the menu area. The doctor may now select “Skin Tags” from the menu area 102 and the descriptor associated with this disease would be added in the medical report area 104 to keep on building the medical report as the medical service is being rendered.

Alternatively, if the disease that the doctor wants to introduce does not exist e.g. newly discovered, the doctor may create a new field by typing in the name and descriptor for the new field. For example, by clicking on or pressing the “create new field” area in the drop down menu a table 124 may appear in which the doctor may type the name and descriptor for the new field, as shown in FIG. 7c.

It is also possible to design the interface whereby selecting the “add new field” option may lead directly to the table 124 for manually entering the new field without passing by a drop down menu. A non limiting example of this implementation is shown in FIG. 7d.

In a further embodiment, it is possible to have the “add new field” option to add a field from the existing fields, and the “create new field” option to create a non-existing field, as shown in FIG. 7e.

To access to the system, each doctor may have an account including a profile and some sort of authentication information e.g. user name and password, fingerprint etc. The account profile may include position information which reflects the doctor's position within the hierarchy of the organization in which the doctor is practicing e.g. clinic, hospital, lab etc. In an embodiment, adding new fields in the interface is subject to a set of policies which are based on the position information associated with each account. Different types of privileges may be provided to different doctors based upon each doctor's position within the hierarchy.

In a non limiting example of implementation, doctors who do not have administrator privileges may only add new types but not new generic names (generic diseases). On the other hand, doctors who do have administrator privileges may add new generic names and new types.

In an embodiment, the interface may provide a choice as to whether the new field will be added to the personal interface of the doctor whereby the new field may become available to the doctor only, or to the department whereby the field may become available to all the practicing doctors of the department. Every doctor may add new fields to their personal interface, but only authorized doctors may add new fields for the entire department.

In another non limiting example of implementation, the position information includes some sort of ranking whereby changes made by a certain doctor apply to doctors/personnel who are of a lower ranking.

In an embodiment, the new fields may be added to the database in a hierarchical manner. For example, if the added field represents a new type of psoriasis, it would appear in the skin diseases and in the nail diseases (since psoriasis affects both the skin and the nails), but not in diseases relating to the heart of or kidney etc.

In an embodiment, when a generic name is added by a doctor who does not have administrator privileges, a notification may be sent to the administrator to seek approval prior to adding the name in the menu area of the interface.

The above description and drawings illustrate an interface including names/codes of diseases in the menu area 102 which may be used for producing medical reports which specify the medical condition of the patient. However, it is to be noted that the embodiments may also be adapted to include other information in the menu area 102 to produce different types of medical reports. For example, instead of having names of diseases it is possible to have names/codes of operations, tests, or medical imaging performed for producing a medical report that specifies the services rendered by the doctor. Such interface may also be used for billing purposes, for example, by assigning a billing code to each name/type in the menu area 102 and summing the fees associated with each diagnosis or service rendered.

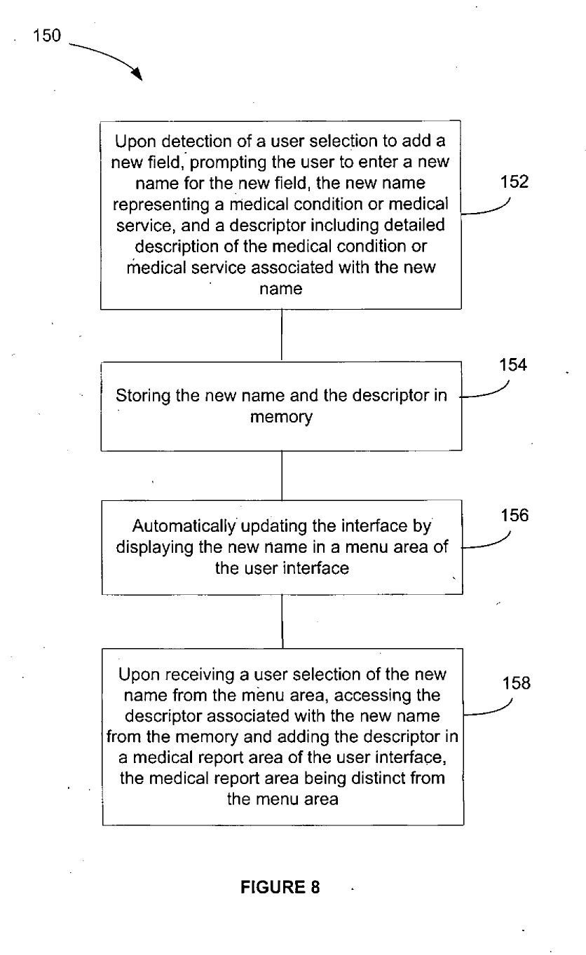

FIG. 8 is a flowchart of a method 150 for updating fields of a user interface (interface) implemented on a display and used for generating automated medical report for a patient, in accordance with an embodiment. Step 152 comprises upon detection of a user selection to add a new field, prompting the user to enter a new name for the new field, the new name representing a medical condition or medical service, and a descriptor including detailed description of the medical condition or medical service associated with the new name. Step 154 comprises storing the new name and the descriptor in memory. Step 156 comprises automatically updating the interface by displaying the new name in a menu area of the user interface. Step 158 comprises upon receiving a user selection of the new name from the menu area, accessing the descriptor associated with the new name from the memory and adding the descriptor in a medical report area of the user interface, the medical report area being distinct from the menu area.

### Hardware and Operating Environment

Embodiments of the invention may be implemented/operated using a client machine. The client machine may be in communication with a remote server via a communication network.

The client machine can be embodied in any one of the following computing devices: a computing workstation; a desktop computer; a tablet, a laptop or notebook computer; a server; a handheld computer; a mobile telephone; a portable telecommunication device; a media playing device; a gaming system; a mobile computing device; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the client machine can be a mobile device such as any one of the following mobile devices: a JAVA-enabled cellular telephone or personal digital assistant (PDA), such as the i55sr, i58sr, i85s, i88s, i90c, i95c1, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein.

Still other embodiments of the client machine include a mobile client machine that can be any one of the following: any one series of Blackberry, Playbook or other handheld device manufactured by Research In Motion Limited; the iPhone manufactured by Apple Computer; Windows Phone 7, HTC, Sony Ericsson, any telephone or computing device running the Android operating system, or any handheld or smart phone; a Pocket PC; a Pocket PC Phone; or any other handheld mobile device supporting Microsoft Windows Mobile Software, etc.

The client machine may include a display and a touch-sensitive surface. It should be understood, however, that the computing device may also include one or more other physical user interface devices, such as a physical keyboard, a mouse and/ or a joystick.

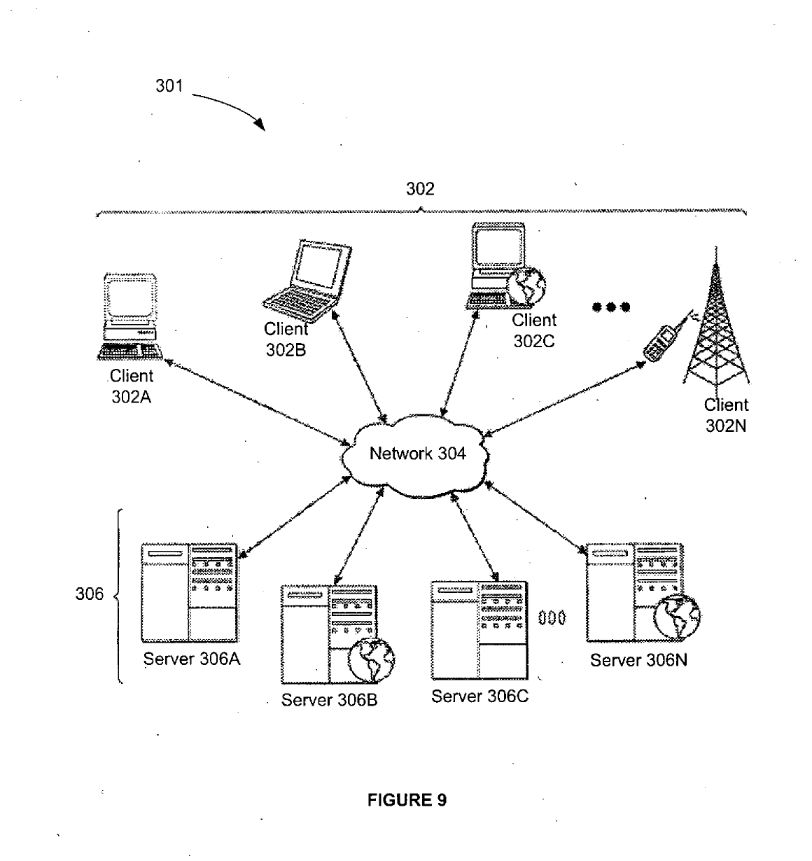

FIG. 9 illustrates an embodiment of a computing environment 301 that includes one or more client machines 302A-302N in communication with servers 306A-306N, and a network 304 installed in between the client machines 302A-302N and the servers 306A-306N. In some embodiments, client machines 302A-302N may be referred to as a single client machine 302 or a single group of client machines 302, while servers may be referred to as a single server 306 or a single group of servers 306. One embodiment includes a single client machine 302 communicating with more than one server 306, another embodiment includes a single server 306 communicating with more than one client machine 302, while another embodiment includes a single client machine 302 communicating with a single server 306.

The client machine 302 may in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 302. Still other embodiments may include a computing environment 301 with an application that is any of either server-based or remote-based, and an application that is executed on the server 306 on behalf of the client machine 302. The client machine 302 may include a network interface to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above.

The computing environment 301 can in some embodiments include a server 306 or more than one server 306 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 306 configured to operate as an active direction; a server 306 configured to operate as application acceleration application that provides firewall functionality, application functionality, or load balancing functionality, or other type of computing machine configured to operate as a server 306. In some embodiments, a server 306 may include a remote authentication dial-in user service such that the server 306 is a RADIUS server.

The network 304 between the client machine 302 and the server 306 is a connection over which data is transferred between the client machine 302 and the server 306. Although the illustration in FIG. 9 depicts a network 304 connecting the client machines 302 to the servers 306, other embodiments include a computing environment 301 with client machines 302 installed on the same network as the servers 306. Other embodiments can include a computing environment 301 with a network 304 that can be any of the following: a local-area network (LAN); a metropolitan area network (MAN); a wide area network (WAN); a primary network comprised of multiple sub-networks located between the client machines 302 and the servers 306; a primary public network with a private sub-network; a primary private network with a public sub-network; or a primary private network with a private sub-network. Still further embodiments include a network 304 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 304 that includes a wireless link where the wireless link can be an infrared channel or satellite band; or any other network type able to transfer data from client machines 302 to servers 306 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 302 to servers 306, and vice versa, to accomplish the methods and systems described herein. Additional embodiments may include a network 304 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for updating fields of a user interface (interface) implemented on a display and used for generating automated medical report for a patient, the method comprising:
upon detection of a user selection to add a new field, prompting the user to enter a new name for the new field, the new name representing a medical condition or medical service, and a descriptor including detailed description of the medical condition or medical service associated with the new name;
storing the new name and the descriptor in memory;
automatically updating the interface by displaying the new name in a menu area of the user interface;
upon receiving a user selection of the new name from the menu area, accessing the descriptor associated with the new name from the memory and adding the descriptor in a medical report area of the user interface, the medical report area being distinct from the menu area.

2. The method of claim 1, wherein prompting comprises displaying a table for the user to enter the new name and the descriptor.

3. The method of claim 1, wherein prompting comprises displaying a browser window or a drop down menu for the user to select a pre-stored field.

4. The method of claim 1, further comprising:
associating an audio clip with the new field, the audio clip representing a reading of at least one of: the medical condition or medical service associated with the new name, and the descriptor associated with the new name;
playing the audio clip upon receiving the user selection of the new name.

5. The method of claim 4, wherein associating comprises one of:
receiving a voice recording of the audio clip;
receiving a user selection of an existing audio clip; and
generating the audio clip using an automated text-to-audio program.

6. The method of claim 1, further comprising, if the new name represents a new medical condition:
adding the new name in the menu area if privileges associated with a profile of the user indicate that the user is allowed to add generic names;

7. The method of claim 6, further comprising sending the new name and the descriptor to an administrator for approval prior to adding the new name in the menu area if privileges associated with the profile of the user indicate that the user is not allowed to add generic names.

8. The method of claim 1, further comprising, if the new name represents a new type of an existing medical condition, adding the new name in a drop down menu, the drop down menu being displayed upon receiving a user selection of the new name that represents the existing medical condition from the menu area.

9. The method of claim 1, classifying the new field under one or more body areas whereby the new name appears in the menu area of the interface upon selection of each body organ under which the new name has been classified.

10. The method of claim 1, further comprising:
storing one or more translations of the new field in memory;
cross referencing the different translations of names and descriptors for each field;
receiving a user selection of a language for at least one of: names in the menu area, descriptors in the medical report area, medical report viewed in the medical report area, medical report to be sent to third parties;
whereby the user may automatically produce equivalent medical reports in different languages.

11. A method for adding new fields in a user interface (interface) used for generating automated medical report for a patient, the interface comprising a menu area and a medical report area distinct from the menu area, the method comprising:
receiving a new name and a descriptor for a new field, the new name representing a medical condition or medical service and the descriptor including detailed description for the new name;
storing the new name and the descriptor in memory;
automatically allocating a space for the new field in the menu area, and automatically displaying the new name in the allocated space;
upon receiving a user selection of the new name from the menu area, adding the descriptor associated with the new name in the medical report area of the user interface to gradually build an automate medical report with every new selection of a name from the menu area.

12. A graphical user interface (interface) on a computing device comprising a memory having stored thereon computer instructions and a processor for executing the instructions for implementing the interface on a display device, the interface comprising:
a menu area comprising a list of names representing medical conditions or medical services;
a new field area which when selected allows for receiving a new name and a descriptor for the new field, adds the new field in the menu area, and adds the new name in the new field;
a medical report area, distinct from the menu area, for adding and displaying descriptors for the names with each user selection of a name from the menu area to generate a medical report.

13. The interface of claim 12, wherein if the new name represents a new type of an existing medical condition, the interface adds the new name in a drop down menu, the drop down menu being displayed upon receiving a user selection of the name that represents the existing medical condition from the menu area.

14. The interface of claim 12, wherein if the new name represents a new medical condition, the interface verifies privileges associated with a profile of the user and adds the new name in the menu area if the privileges indicate that the user is allowed to add generic names, or sends the new name and the descriptor to an administrator for approval prior to adding the name in the menu area if the privileges indicate that the user is not allowed to add generic names.

15. The interface of claim 12, further comprising a language selection area which allows for selecting a language for at least one of: the names in the menu area and the medical report in the medical report area.

16. The interface of claim 12, further comprising a file insertion area which allows for selecting a file and inserting one of: the file, a link thereto, and a sample thereof in the medical report area.

17. The interface of claim 12, wherein upon detecting a user selection of a name from the menu area the interface causes the processor to play an audio clip representing a reading of the name and/or the descriptor associated with the name.

18. The interface of claim 12, wherein upon detecting a user selection of a name representing a medical condition or a medical service having different types, the interface displays at least a portion of the different types in a drop down menu.

19. The interface of claim 12, further comprising a tree-view area for displaying the names selected by the user in an order of selection, wherein changing the order of a selected name from the tree-view area causes an automatic change of order of the descriptor associated with the selected name in the medical report area.
